(19) United States
(12) Patent Application Publication
(10) Pub. No.: US 2023/0041718 A1
(43) Pub. Date: Feb. 9, 2023

(54) AUTOMATED CODE GENERATION BASED ON PSEUDO-CODE

(71) Applicants: Kenneth Raymond Perry, Atlanta, GA (US); Zaire Ali, Grovetown, GA (US)

(72) Inventors: Kenneth Raymond Perry, Atlanta, GA (US); Zaire Ali, Grovetown, GA (US)

(21) Appl. No.: 17/880,870

(22) Filed: Aug. 4, 2022

Related U.S. Application Data
(60) Provisional application No. 63/231,017, filed on Aug. 9, 2021.

(51) Int. Cl. G06F 8/35; G06F 8/20; G06F 8/10

(52) U.S. Cl. CPC G06F 8/35; G06F 8/20; G06F 8/10

(57) ABSTRACT

A solution to the problems caused by manual computer programming is provided. A Pseudo-code Design Platform (PDP) reduces the amount of technical skill, length of time, and cost required to create and maintain computer applications. The Pseudo-code Compiler performs as a true Integrated Design Environment. All of the software development steps are performed automatically 100% of the time, within the Pseudo-code Design Platform, just in the opposite order of the conventional process.

### TECHNICAL FIELD

This present disclosure generally relates to software development, and more particularly, to automated code generation using pseudo-code.

### BACKGROUND

Software has been used to automate and simplify our lives as technology, computers, and devices are more commonplace. Software is developed to both simplify and solve problems. The software development process is the process used to develop computer programs. In most instances, a computer program is written in a computer programming language, which is a language designed to communicate instructions to a computer.

The conventional software development process results in a low productivity of critical, highly skilled, well-paid workers in an information economy driven by software applications. The conventional software development process does not address the root problem of the bottleneck of the software industry created by manual coding. This fact coupled with more and more software solutions being created and used in the numerous electronic devices that are present today, there is a need to provide a more simple, efficient, effective, and more autonomous/automated software generating solution.

Accordingly, a pseudo-code compiler that addresses a problem of labor-intensive manual coding is desired. The present disclosure provides an innovative and effective solution to this problem.

### BRIEF OVERVIEW

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

Additional aspects of the disclosure will be set forth in part in the description which follows, and in part will be obvious from the description, or can be learned by practice of the disclosure. The advantages of the disclosure will be realized and attained by means of the elements and combinations particularly pointed out in the appended claims. It is to be understood that both the foregoing general description and the following detailed description are and explanatory only and are not restrictive of the disclosure, as claimed.

One example embodiment provides a solution to the problems caused by manual computer programming. The proposed Pseudo-code Design Platform (PDP) reduces the amount of technical skill, length of time, and cost required to create and maintain computer applications. The Pseudo-code Compiler performs as a true Integrated Design Environment. All of the development steps are performed automatically 100% of the time, within the Pseudo-code Design Platform, just in the opposite order of the conventional process.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the Applicants. The Applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 illustrates a comparison between the top-level architecture of the Pseudo-code Compiler, and the top-level architecture of the conventional development environment;

FIGS. 2A-2J illustrate an embodiment of the Pseudo-code Design Platform creating and executing a Pseudo-code Design Outline to compute the volume of a box and generating computer source code in three common programming languages, according to at least one embodiments;

FIG. 3 illustrates the Pseudo-code Processor Component, according to at least one embodiments; and

FIG. 4 illustrates a Settings Template, according to at least one embodiments and FIG. 5 is a block diagram of a system including a computing device for performing the function of the Pseudo-code Compiler according to at least one embodiment.

### DETAILED DESCRIPTION

The present disclosure includes many aspects and features. Moreover, while many aspects and features relate to, and are described in, the context of software development, and more particularly, to automated code generation using pseudo-code, embodiments of the present disclosure are not limited to use only in this context. The present disclosure can be understood more readily by reference to the following detailed description of the disclosure and the Examples included therein.

Before the present articles, systems, apparatuses, and/or methods are disclosed and described, it is to be understood that they are not limited to specific manufacturing methods unless otherwise specified, or to particular materials unless otherwise specified, as such can, of course, vary. It is also to be understood that the terminology used herein is for the purpose of describing particular aspects only and is not intended to be limiting. Although any methods and materials similar or equivalent to those described herein can be used in the practice or testing of the present disclosure, example methods and materials are now described.

### Definitions

It is also to be understood that the terminology used herein is for the purpose of describing particular aspects only and is not intended to be limiting. As used in the specification and in the claims, the term “comprising” can include the aspects “consisting of” and “consisting essentially of.” Unless defined otherwise, all technical and scientific terms used herein have the same meaning as commonly understood by one of ordinary skill in the art to which this disclosure belongs. In this specification and in the claims which follow, reference will be made to a number of terms which shall be defined herein.

As used in the specification and the appended claims, the singular forms “a,” “an” and “the” include plural referents unless the context clearly dictates otherwise. Thus, for example, reference to “an opening” can include two or more openings.

Ranges can be expressed herein as from one particular value, and/or to another particular value. When such a range is expressed, another aspect includes from the one particular value and/or to the other particular value. Similarly, when values are expressed as approximations, by use of the antecedent ‘about,’ it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

The terms “first,” “second,” “first part,” “second part,” and the like, where used herein, do not denote any order, quantity, or importance, and are used to distinguish one element from another, unless specifically stated otherwise.

As used herein, the terms “optional” or “optionally” means that the subsequently described event or circumstance can or cannot occur, and that the description includes instances where said event or circumstance occurs and instances where it does not. For example, the phrase “optionally affixed to the surface” means that it can or cannot be fixed to a surface.

Moreover, it is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of aspects described in the specification.

Disclosed are the components to be used to manufacture the disclosed apparatuses, systems, and articles of the disclosure as well as the apparatuses themselves to be used within the methods disclosed herein. These and other materials are disclosed herein, and it is understood that when combinations, subsets, interactions, groups, etc. of these materials are disclosed that while specific reference of each various individual and collective combinations and permutation of these materials cannot be explicitly disclosed, each is specifically contemplated and described herein. For example, if a particular material is disclosed and discussed and a number of modifications that can be made to the materials are discussed, specifically contemplated is each and every combination and permutation of the material and the modifications that are possible unless specifically indicated to the contrary. Thus, if a class of materials A, B, and C are disclosed as well as a class of materials D, E, and F and an example of a combination material, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the articles and apparatuses of the disclosure. Thus, if there are a variety of additional steps that can be performed it is understood that each of these additional steps can be performed with any specific aspect or combination of aspects of the methods of the disclosure.

It is understood that the apparatuses and systems disclosed herein have certain functions. Disclosed herein are certain structural requirements for performing the disclosed functions, and it is understood that there are a variety of structures that can perform the same function that are related to the disclosed structures, and that these structures will typically achieve the same result.

It will be readily understood that the instant components, as generally described and illustrated in the figures herein, may be arranged and designed in a wide variety of different configurations. Thus, the following detailed description of the embodiments of at least one of a method, apparatus, non-transitory computer readable medium and system, as represented in the attached figures, is not intended to limit the scope of the present disclosure as claimed but is merely representative of selected embodiments.

The instant features, structures, or characteristics as described throughout this specification may be combined in any suitable manner in one or more embodiments. For example, the usage of the phrases “example embodiments”, “some embodiments”, or other similar language, throughout this specification refers to the fact that a particular feature, structure, or characteristic described in connection with the embodiment may be included in at least one embodiment. Thus, appearances of the phrases “example embodiments”, “in some embodiments”, “in other embodiments”, or other similar language, throughout this specification do not necessarily all refer to the same group of embodiments, and the described features, structures, or characteristics may be combined in any suitable manner in one or more embodiments.

In addition, while the term “message” may have been used in the description of embodiments, the application may be applied to many types of network data, such as, packet, frame, datagram, etc. The term “message” also includes packet, frame, datagram, and any equivalents thereof. Furthermore, while certain types of messages and signaling may be depicted in the one or more embodiments they are not limited to a certain type of message, and the application is not limited to a certain type of signaling.

A typical software development process is composed of five major steps:
1. Requirements
2. Specifications (Analysis and Design)
3. Implementation
4. Integration
5. Testing.

Typically, the software process begins with the Requirements phase, where the system requirements are gathered. These requirements are used to develop an abstract description containing unspecified details of the system.

This is followed by the specifications phase. During the specifications phase, the problem is analyzed and solved. A developer analyzes the problem and plans the sequence of steps of the problem solution from the input to the output. Most programs require planning and design. The user experience/user interface (UI/UX) pertaining to the appearance of the screens must be planned and designed including the way information is presented to the user. During the specifications phase, the mathematical and logical equations necessary to process any information must be planned. The logical flow of the instructions and information must be planned. Also during this phase, technical manuals help systems, and other forms of documentation must be planned and designed.

The Specifications phase is further subdivided into two levels of abstraction:
1. Analysis
2. Design.
   Abstraction is used to manage the complexity of the design of the system. Abstraction is a method that only presents the details of a problem that are essential to the user at that time.

During the Analysis sub-phase, the problem is analyzed and an algorithm is created. An algorithm is the solution to a problem in concrete, unambiguous steps.

During the Implementation phase, the algorithm is translated into a computer programming language. This is called computer programming or coding. The conventional method requires the implementation phase to be performed manually. The present disclosure provides for an improved method which reduces the required skilled labor and man hours to complete the implementation.

During the Integration phase, the computer program developed during the Implementation phase, is integrated into the larger system being developed. Testing is done repeatedly throughout the process.

The process is not linear, it is iterative. As new requirements are added, the process may be repeated.

Conventional software development has the following shortcomings:
1. The software development requires that the Implementation phase of the process be done manually.
2. It takes highly-skilled people to write and maintain computer code.
3. The process of manual coding is the most tedious, frustrating, error-prone, time-consuming and expensive part of the software development process.
4. Manual programming is the bottleneck in the software industry.

Further, the Design phase and the Implementation phase of the software development process become intertwined during testing, making it difficult to separate the design errors from the coding errors, thus, making it even more difficult to troubleshoot run-time errors. Thus, the conventional software development process results in a low productivity of critical, highly-skilled, well-paid workers in an information economy driven by software applications. The conventional software development process does not address the root problem of the bottleneck of the software industry created by manual coding.

Accordingly, a pseudo-code compiler that addresses a problem of labor-intensive manual coding is desired. Again, the present disclosure provides for an improved method which reduces the required skilled labor and man hours to complete the implementation.

Example embodiments provide methods, systems, components, non-transitory computer readable media, devices, and/or networks, which provide for automated code generation based on pseudo-code.

At least one embodiment provide solutions to the problems caused by manual computer programming. The proposed Pseudo-code Design Platform (PDP) reduces the amount of technical skill, length of time, and cost required to create and maintain computer applications. In one embodiment, the Pseudo-code Design Platform solves this problem by providing:
a user-defined computer program design language that is only five words long. This reduces syntax errors and simplifies the code parser;
a computer program product which provides a method that captures all the required information from the user to design a software application without writing the application in any computer programming language;
a computer program product which eliminates spelling, syntax and semantics errors;
a computer program product that automatically executes the design outline and generates the program code in any selected computer programming language;
a method that eliminates the need to write or compile a computer program code at all;
one or more design entry templates that provide a user with capability of capturing the design logic of the system in such a way that all needed information is acquired to execute an instruction;
a Structured Programming Instruction Manager that is responsible for instruction management, organization, interaction, execution and serialization;
a Structured Programming Instruction Manager that verifies all data and handles instruction nesting;
a Structured Programming Instruction Manager that guarantees that only executable statements can be generated;
a method for separating the Design phase from the Implementation phases of the software development cycle.

As discussed above, the main problem with the conventional development process is that the Implementation phase of the software development process is done manually. This results in low productivity for high-skilled, highly-paid professionals within the software industry.

According to at least one embodiment, a natural language processor may be used. The natural language processor may be configured such that when a user may input natural language, the processor may generate and execute code based on the natural language conversion into a programming language and instructions. The resulting programming language and instructions may then be processed such that they may be executed accordingly. In at least one instance, the natural language input will be processed and executed providing for the following flow of information and execution: input natural language instruction, output programming language instruction, compute per instruction, and provide resultant and/or decision based on instruction and execution. In at least one instance, this may be repeated via a repetition process as needed.

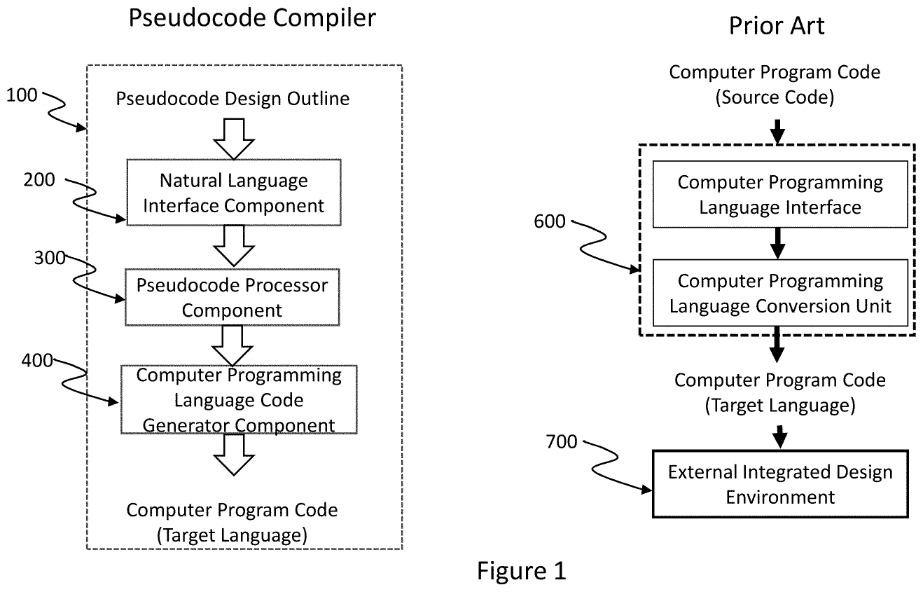

FIG. 1 shows a comparison of at least one embodiment of a Pseudo-code Compiler and the conventional development process. The conventional systems all input a high-level (English-like) computer program written in one of computer programming language and convert/translate it to another high-level computer programming language. Thus, all of these conversion/transformation methods just map one high-level computer programming language (i.e., word-pairs, word phrases, and code segments) to another. The transformation process requires recognition of thousands of combinations of words, phrases, and code segments to determine the input language and map it to the output target language. This seldom works 100% of the time. Yet, the process does nothing to address the software productivity problem, or the execution of the target code. The user still has to transfer the source code into executable code and run it, i.e.:
Load—i.e., load the source code into an Integrated Design Environment 700 where the target computer program is compiled into object code;
Link—i.e., link multiple object files into one executable file, and
Run the executable—i.e., brings the multiple object files from disk to memory and runs/executes the program.

The purpose of creating computer source code in the first place is to run the application/program. The Pseudo-code Compiler performs as a true Integrated Design Environment. All of the above steps are performed automatically 100% of the time, within the Pseudo-code Design Platform, just in the opposite order of the conventional process. The conventional process requires a much larger input solution space to recognize, analyze, and map one programming language to another. For example, C++ programming language has 97 keywords, Java programming language has 53 words, C programming language has 33 keywords. Thus, an exponentially greater number of possible word phrases and code segments are needed to be read and evaluated.

The conventional systems may require some form of machine learning to identify matching code phrases. Even then, it does not work correctly 100%. The proposed Pseudo-code Compiler does not require any forms of machine learning. It is not necessary because of the small number of words (5) that needs to be recognized. The Pseudo-code Compiler works 100% of the time.

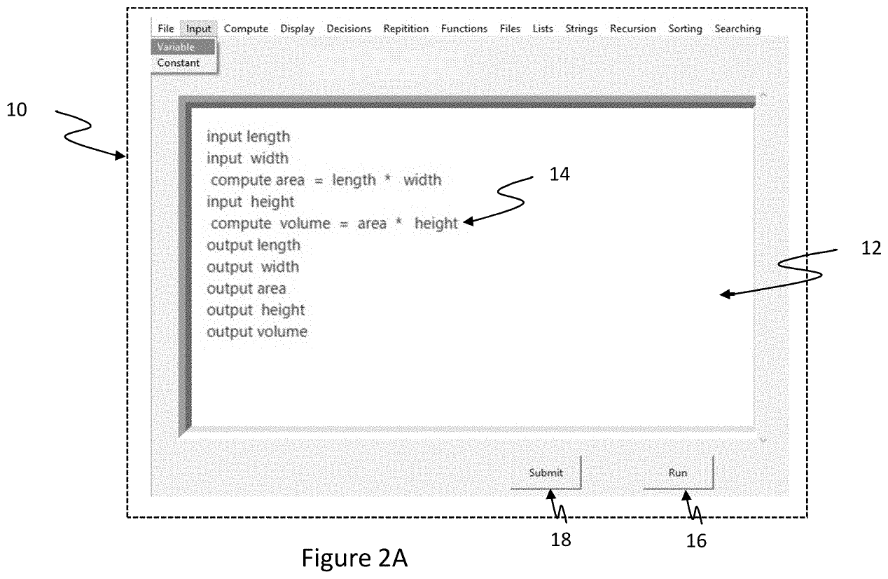

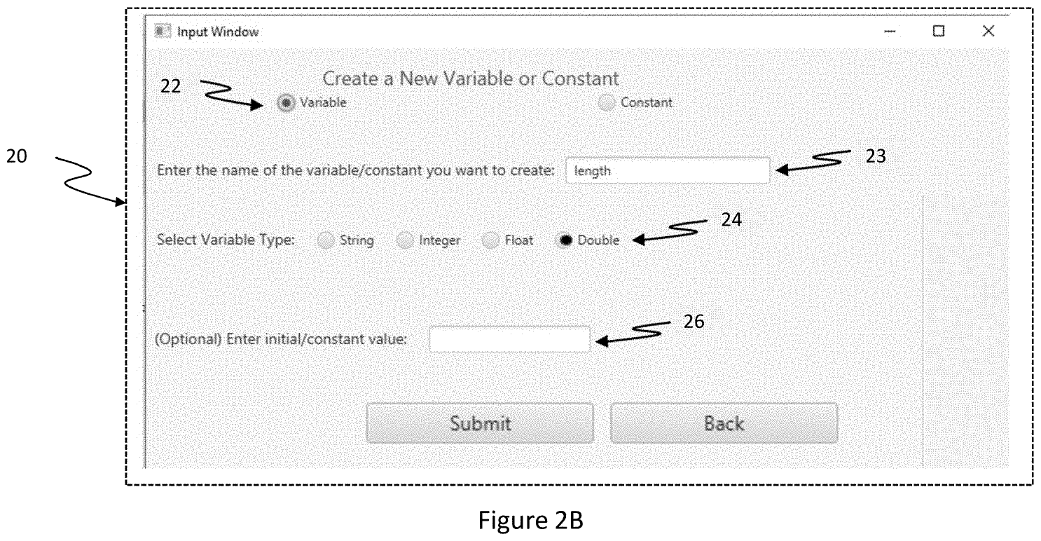

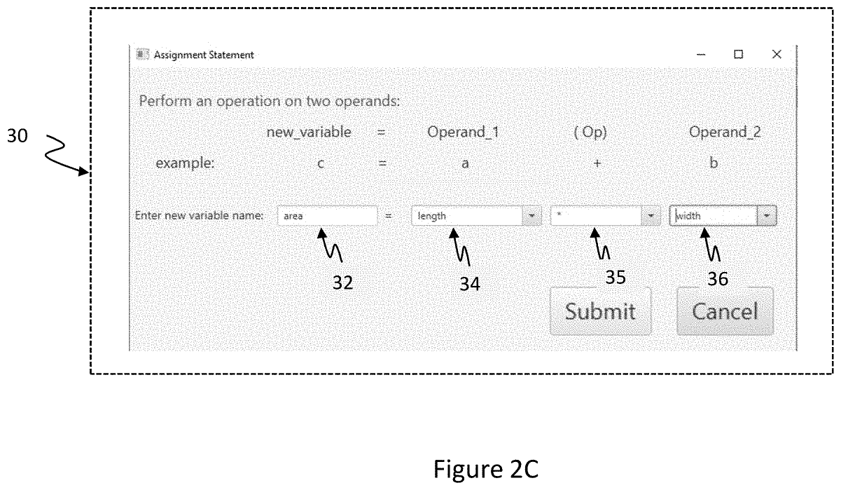

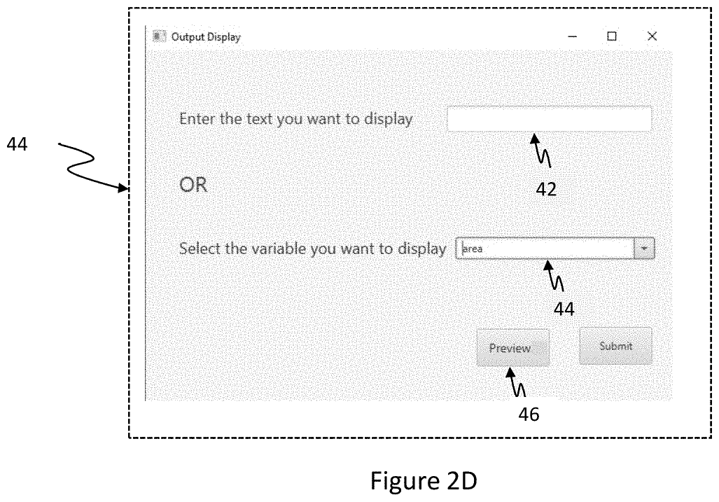

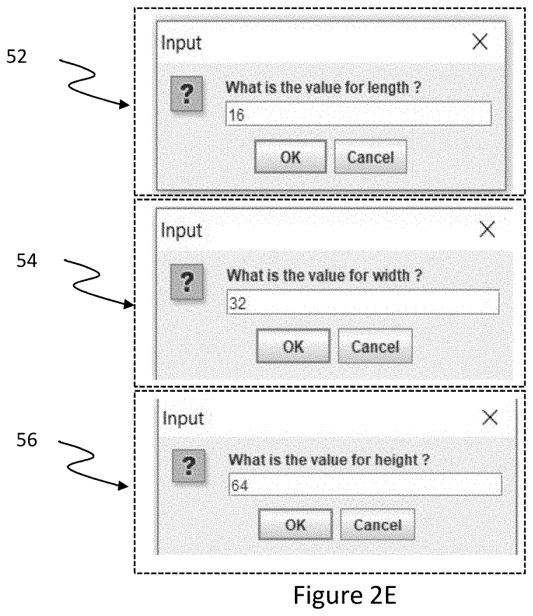

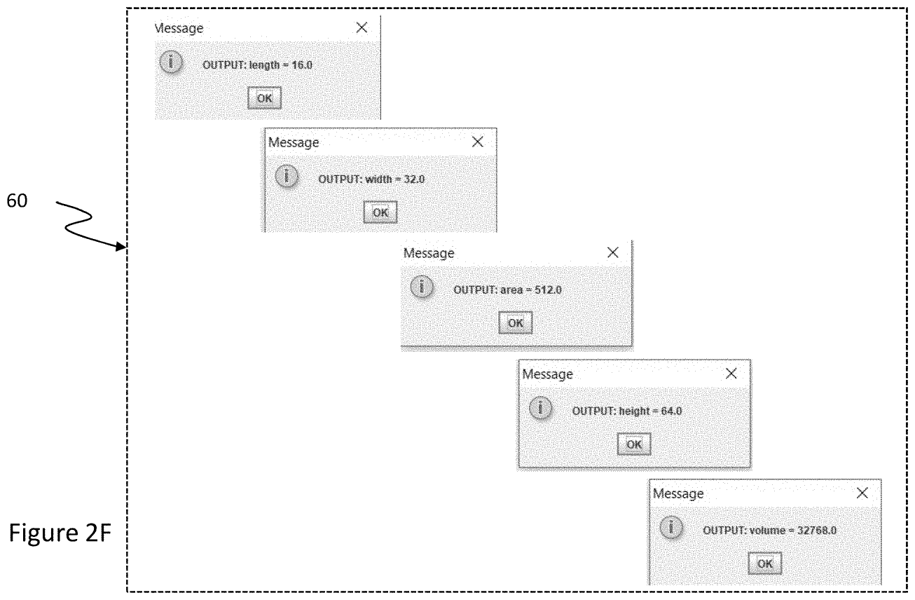

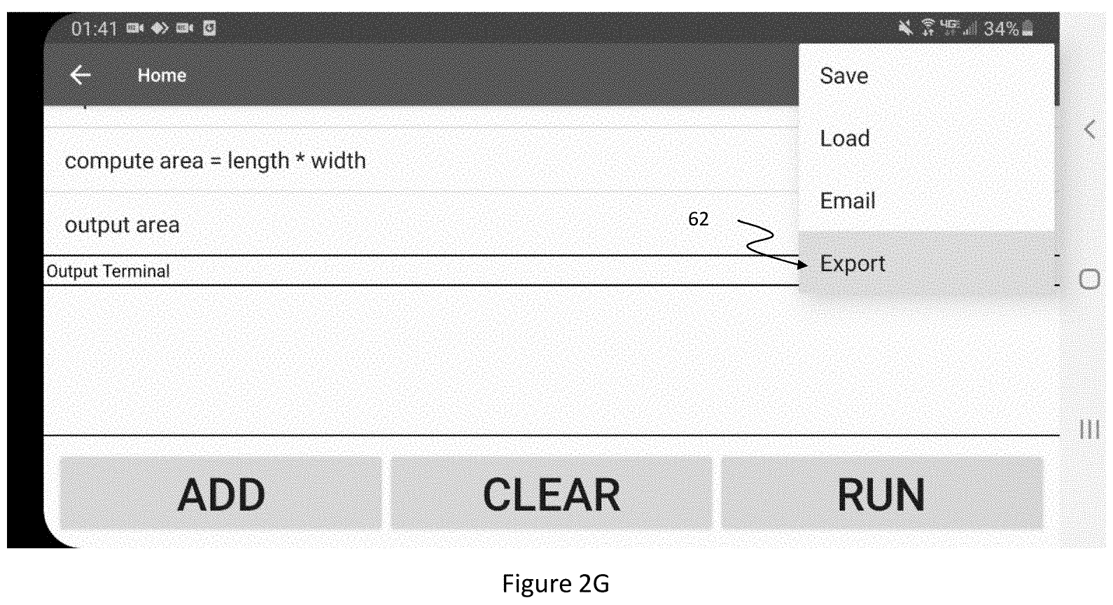

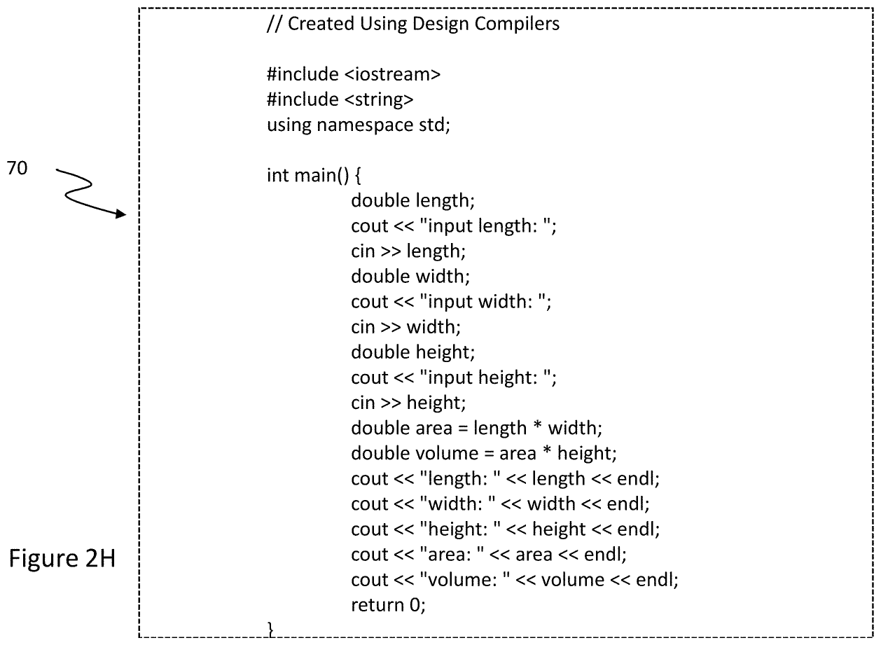

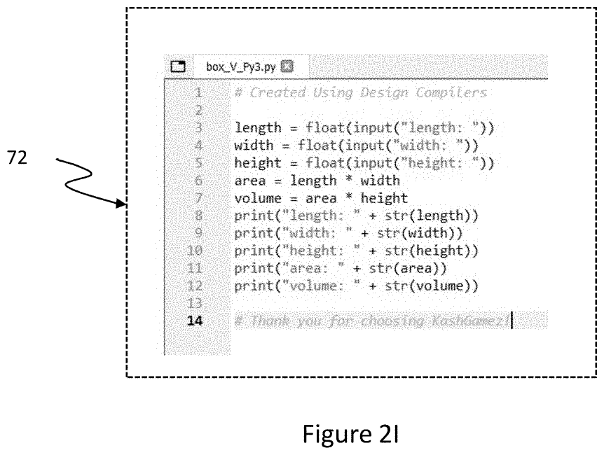

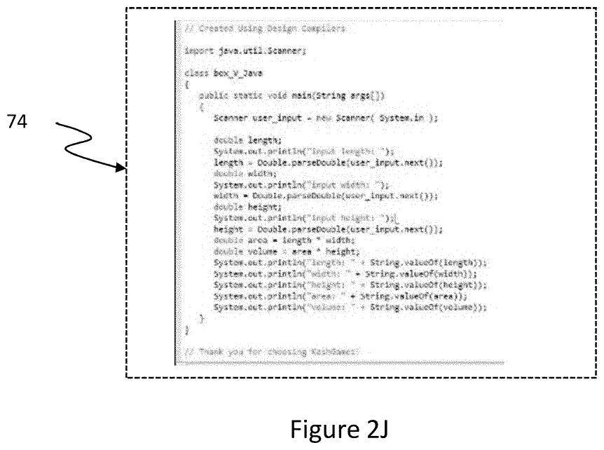

According to at least one embodiment, the Pseudo-code Compiler performs code generation by first executing the design 14 (Pseudo-code Design Outline in FIG. 2). Then it generates a copy of the computer program that just ran. The Pseudo-code Compiler just recognizes only 5 words, which are user-defined. Also, the Pseudo-code Design Platform does not require for a computer program ever to be written. In one embodiment, the Design platform, advantageously, enables the user to enter an outline in his or her native language, push a button and generate the code, without ever writing a computer program.

To reinforce the concept of the natural language front end, only 5 words are used. The default words are provided. The option also exists for the user to substitute their preferred words for the default words. Other commonly used terms may be provided in the setup form, from a selection combo box. The design system only requires the user to enter the names of their variables. After being submitted to the data dictionary, these variable names are selected from drop-down combo boxes. This eliminates spelling errors.

One of the benefits of the example embodiments is that it improves the functionality of a computing system/server by implementing a method for automated code generation.

Accordingly, at least one embodiment provide for a specific solution to a problem in the field of software development. According to at least one embodiment, a method, system and a computer readable medium for automated code generation are provided.

The solution described herein allows for execution of a pseudo-code that may be defined as a plain language description of the steps in an algorithm intended for human reading and not machine reading. It is a language used to help the user think through the problem before attempting to write it in a computer programming language.

At least one method first involves creating a Pseudo-code Design outline. The method then executes the Design outline. These simulations are used to verify the design of the application being developed. This separates the Design phase from the Implementation phase. A user gets to determine if their design works, first. Then, after the design is proven correct, the user has the option of writing the code manually, or using the code generator to automatically generate the code.

The user may select a programming language, and the code generator outputs source code in the chosen language. The computer program product described herein automates the Implementation phase of the software product development process, thus eliminating the most frustrating, tedious, time-consuming, error-prone, and expensive part of the software development process.

As discussed above, embodiments of the present disclosure provide an integrated design environment which allows users to develop computer software applications. A user can access the integrated design environment through an interface, such as a web browser or a dedicated application running on a Smartphone, desktop, laptop, or tablet computer. The user can then create a project from scratch or retrieve an existing project from storage. The user can display and modify the file in the editor of the integrated design environment via a display screen.

Reference will now be made in detail to at least one embodiments. FIG. 2A illustrates an embodiment of an editor 12 within an integrated design environment 10 creating and running a Pseudo-code Design outline 14 to compute the volume of a box. First, the variables are input using the Input Window 20, as shown in FIG. 2B. The User positions the curser where they want to insert instructions. All necessary parameters/options are also specified at this time.

This template provides the user with means to declare and define new variables or constants. The template asks all the questions needed to input and validate the new variable or constant name 23, type 24, and (optional) value 26. This information is stored internally in a data dictionary. The data dictionary stores the data type plus all other information about all variables. This eliminates the necessity for the user to remember variable names, their type and spelling. Furthermore, use of the new variable is obtained by selecting it from a drop-down list. This eliminates spelling errors.

One embodiment of the Sequence window 30 is shown in FIG. 2C. This figure shows that the variables area 32, length 34, and width 36 are obtained from drop-down lists. Note that the operator 35 is also obtained from a drop-down list. This method presents to the user all operations available for use by the user for the selected types of data. This also reduces errors.

FIG. 2D illustrates an embodiment of the Output window 44, which provides a text area for the user to enter text to appear on the screen 42, or a scrollable drop-down list of validated output variables 44. The Preview button 46 provides the user with a preview of the display without running a program. When the user pushes the Run button 16, the Pseudo-code Processor 300 reads, and directly executes the Pseudo-code Design outline. The interface in the FIG. 2E first asks the user to input values for the three variables 52, 54, and 56.

After running the Pseudo-code Design Outline, the output 60 is displayed as shown in FIG. 2F. At any time of the process, FIG. 2G shows an embodiment of the user selecting to export computer generated source files 62 in multiple languages. FIG. 2H shows an embodiment of the generated output computer source 70 code in C++. FIG. 2I illustrates an embodiment of the generated output computer source 72 code in Python, and FIG. 2J shows an embodiment of the generated output computer source 74 code in Java.

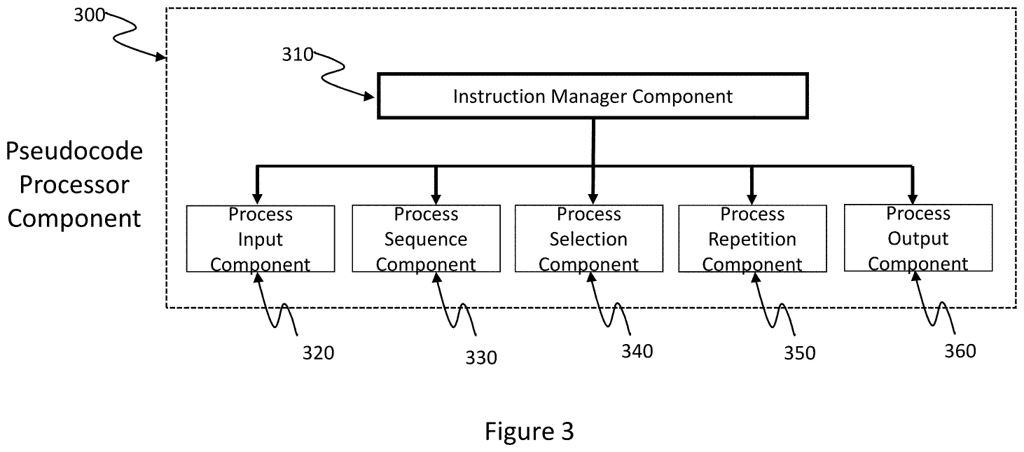

FIG. 3 shows the architectural organization of the Pseudo-code Processor 300. The Pseudo-code Processor method is a behavioral model of a Central Processing Unit (CPU) of a Reduced Instruction Set Computer (RISC) computer. Thus, it can be implemented in hardware or software. The architecture of the Pseudo-code Processor 300 is a simple model of a computer, where a computer does only three major tasks: input, processing, and output. The design of the Pseudo-code Processor 300 is based upon automata theory (In 1966, Bohm, C., and G. Jacopini, “Flow Diagrams, Turing Machines, and Languages with Only Two Formation Rules,” Communications of the ACM, Vol. 9, No. 5, May, 1966, pp. 366-371) proved that all computer programs could be written in terms of only 3 control structures: sequence structure, selection structure, and repetition structure.

These three control structures control the order in which instructions are executed. The Instruction Manager 310 is responsible for control of the Pseudo-code Processor, and the organization, interaction, execution and serialization of all of the instructions. It also verifies all data and handles instruction nesting. The Instruction Manager 310 determines what questions to ask to cause the user input the necessary parameters, variables, and instruction type, and determines the order of the instructions to be executed; and determines which instructions require their own Instruction Manager 310.

The user interface is built using an object-oriented, model-view-controller (MVC) design pattern. The view provided to the user is a list of instructions, outputs, and action buttons that they can take. The action buttons serve as the controller that takes pseudo-code instructions from a user and populates the view and translates the instruction for the model. Upon launch, the Instruction Manager method creates a root instance of the Instruction Manager 310. The object holds instructions, other Instruction Managers, and outputs upon execution. For ease of management, the instructions are implemented as classes that hold what action to perform, variable names, data types, etc. Users interact with the graphical user interface (GUI) to select which instructions they want to add to the Instruction Manager 310. When adding instructions such as OUTPUT that are dependent on previously defined variables, the Instruction Manager 310 denotes which previous variables are compatible. This allows every instruction list created to become executable.

The Instruction Manager 310 also handles input, output and the three control structures: sequence, selection, and repetition. When these functions are required, a new Instruction Manager 310 is created to hold the respective code block. This is also how nested conditions and repetition are handled. Upon the assembly of a desired instruction list, users are able to execute the Instruction Manager 310 with the click of a button. The execute function takes a structured programming approach by iterating over the instruction list and not proceeding until the current instruction or Instruction Manager 310 has completed. This is accomplished by implementing a listener that is triggered by the successful execution of an instruction.

The Instruction Manager class also contains a function to serialize and deserialize an instance of itself. This is used to export and import instruction lists as well as to translate the contained instructions into fully compliable and executable code of the user's choice. This method is fundamentally different from conventional approaches, because instead of translating between two preexisting programming languages, a proprietary Instruction Manager is deserialized. This prevents issues with translating between two languages that are frequently caused by the lack of 1-to-1 translations available. At least one approach prevents issues such as this by translating directly from a single proprietary Instruction Manager.

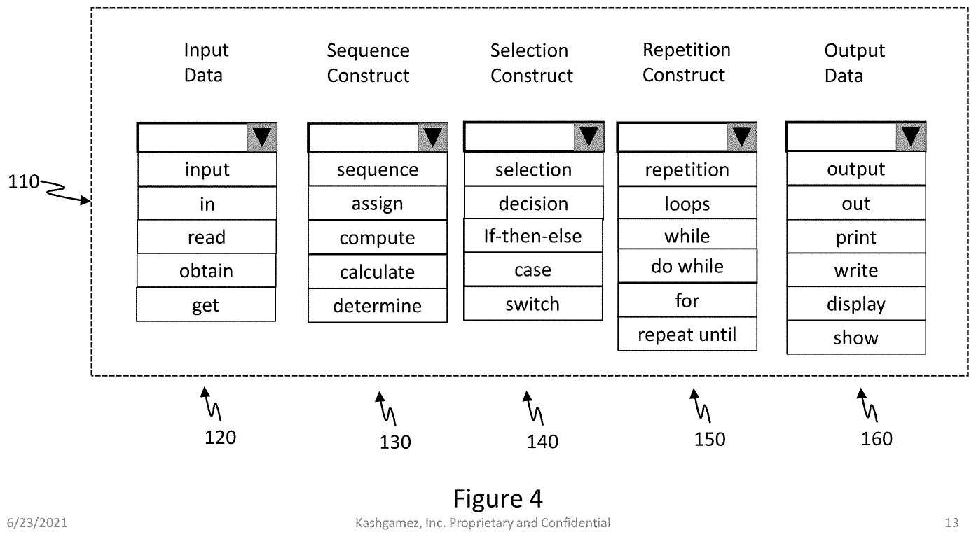

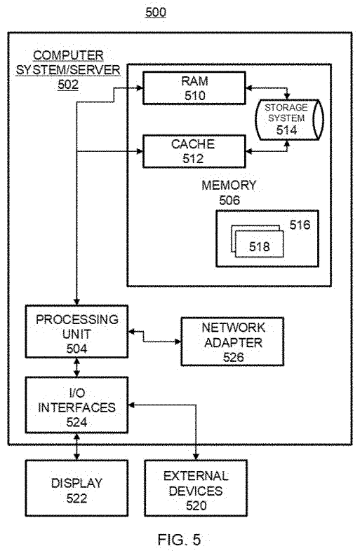

According to at least one embodiments, there are five tasks controlled by the Instruction Manager 310: input, output, sequence, selection, and repetition. These are the default terms. FIG. 4 shows how the user can substitute their preferred terms in the Settings window 110. Therefore, at least one approach limits the input solution space to only 5 words. Thus, at least one Natural Language Interface Component 200 is a simple parser.

The above embodiments may be implemented in hardware, in a computer program executed by a processor, in firmware, or in a combination of the above. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

An exemplary storage medium may be coupled to the processor such that the processor may read information from, and write information to, the storage medium. In the alternative, the storage medium may be integral to the processor. The processor and the storage medium may reside in an application specific integrated circuit (“ASIC”). In the alternative, the processor and the storage medium may reside as discrete components. For example, FIG. 5 illustrates an example computer system/server node 500, which may represent or be integrated in any of the above-described components, etc.

FIG. 5 is not intended to suggest any limitation as to the scope of use or functionality of embodiments of the application described herein. Regardless, the computing node 500 is capable of being implemented and/or performing any of the functionality set forth hereinabove.

In the computing node 500 there is a computer system/server 502, which is operational with numerous other general purposes or special purpose computing system environments or configurations. Examples of well-known computing systems, environments, and/or configurations that may be suitable for use with computer system/server 502 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 502 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 502 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 5, the computer system/server 502 may be used in cloud computing node 900 shown in the form of a general-purpose computing device. The components of the computer system/server 502 may include, but are not limited to, one or more processors or processing units 504, a system memory 506, and a bus that couples various system components including system memory 506 to processor 504.

The bus represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

At least one computer system/server 502 typically includes a variety of computer system readable media. Such media may be any available media that is accessible by the computer system/server 502, and it includes both volatile and non-volatile media, removable and non-removable media. System memory 506, in one embodiment, implements the flow diagrams of the other figures. The system memory 506 can include computer system readable media in the form of volatile memory, such as random-access memory (RAM) 510 and/or cache memory 512. The computer system/server 502 may further include other removable/non-removable, volatile/non-volatile computer system storage media. By way of example only, storage system 514 can be provided for reading from and writing to a non-removable, non-volatile magnetic media (not shown and typically called a “hard drive”). Although not shown, a magnetic disk drive for reading from and writing to a removable, non-volatile magnetic disk, and an optical disk drive for reading from or writing to a removable, non-volatile optical disk such as a CD-ROM, DVD-ROM or other optical media can be provided. In such instances, each can be connected to the bus by one or more data media interfaces. As will be further depicted and described below, memory 906 may include at least one program product having a set (e.g., at least one) of program modules that are configured to carry out the functions of various embodiments of the application.

Program/utility 516, having a set (at least one) of program modules 518, may be stored in memory 506 by way of example, and not limitation, as well as an operating system, one or more application programs, other program modules, and program data. Each of the operating system, one or more application programs, other program modules, and program data or some combination thereof, may include an implementation of a networking environment. Program modules 518 generally carry out the functions and/or methodologies of various embodiments of the application as described herein.

As will be appreciated by one skilled in the art, aspects of the present application may be embodied as a system, method, or computer program product. Accordingly, aspects of the present application may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present application may take the form of a computer program product embodied in one or more computer readable medium(s) having computer readable program code embodied thereon.

The computer system/server 502 may also communicate with one or more external devices 520 such as a keyboard, a pointing device, a display 522, etc.; one or more devices that enable a user to interact with computer system/server 502; and/or any devices (e.g., network card, modem, etc.) that enable computer system/server 502 to communicate with one or more other computing devices. Such communication can occur via I/O interfaces 524. Still yet, the computer system/server 502 can communicate with one or more networks such as a local area network (LAN), a general wide area network (WAN), and/or a public network (e.g., the Internet) via network adapter 526. As depicted, network adapter 526 communicates with the other components of computer system/server 502 via a bus. It should be understood that although not shown, other hardware and/or software components could be used in conjunction with computer system/server 502. Examples include, but are not limited to: microcode, device drivers, redundant processing units, external disk drive arrays, RAID systems, tape drives, and data archival storage systems, etc.

Although in one or more embodiments of at least one of a system, method, and non-transitory computer readable medium has been illustrated in the accompanied drawings and described in the foregoing detailed description, it will be understood that the application is not limited to the embodiments disclosed, but is capable of numerous rearrangements, modifications, and substitutions as set forth and defined by the following claims. For example, the capabilities of the system of the various figures can be performed by one or more of the modules or components described herein or in a distributed architecture and may include a transmitter, recipient or pair of both. For example, all or part of the functionality performed by the individual modules, may be performed by one or more of these modules. Further, the functionality described herein may be performed at various times and in relation to various events, internal or external to the modules or components. Also, the information sent between various modules can be sent between the modules via at least one of: a data network, the Internet, a voice network, an Internet Protocol network, a wireless device, a wired device and/or via plurality of protocols. Also, the messages sent or received by any of the modules may be sent or received directly and/or via one or more of the other modules.

One skilled in the art will appreciate that a “system” could be embodied as a personal computer, a server, a console, a personal digital assistant (PDA), a cell phone, a tablet computing device, a Smart phone or any other suitable computing device, or combination of devices. Presenting the above-described functions as being performed by a “system” is not intended to limit the scope of the present application in any way but is intended to provide one example of many embodiments. Indeed, methods, systems and apparatuses disclosed herein may be implemented in localized and distributed forms consistent with computing technology.

It should be noted that some of the system features described in this specification have been presented as modules, in order to more particularly emphasize their implementation independence. For example, a module may be implemented as a hardware circuit comprising custom very large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together but may comprise disparate instructions stored in different locations which, when joined logically together, comprise the module and achieve the stated purpose for the module. Further, modules may be stored on a computer-readable medium, which may be, for instance, a hard disk drive, flash device, random access memory (RAM), tape, or any other such medium used to store data.

Indeed, a module of executable code could be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations including over different storage devices, and may exist, at least partially, merely as electronic signals on a system or network.

It will be readily understood that the components of the application, as generally described and illustrated in the figures herein, may be arranged and designed in a wide variety of different configurations. Thus, the detailed description of the embodiments is not intended to limit the scope of the application as claimed but is merely representative of selected embodiments of the application.

One having ordinary skill in the art will readily understand that the above may be practiced with steps in a different order, and/or with hardware elements in configurations that are different than those which are disclosed. Therefore, although the application has been described based upon these preferred embodiments, it would be apparent to those of skill in the art that certain modifications, variations, and alternative constructions would be apparent.

While preferred embodiments of the present application have been described, it is to be understood that the embodiments described are illustrative only and the scope of the application is to be defined solely by the appended claims when considered with a full range of equivalents and modifications (e.g., protocols, hardware devices, software platforms, etc.) thereto.

What is claimed is:

1. A computer program product for facilitating processing within a computing environment, the computer program product comprising:
a processor;
a memory, wherein the memory stores a set of instructions for execution on the processor;
the set of instructions comprising:
capturing information from a user;
processing the captured user information;
outputting the processed user information into computer program code of a computer programming language; and
executing by the processor, the computer program code.

2. The computer program product of claim 1 further comprising:
automatically translating the processed user information into a pseudocode design code; and
transforming the pseudocode design code into a computer program in a user selected computer programming language.

3. The computer program product of claim 1 further comprising: wherein the user selected computer programming language is a user-defined computer program design language that is only 5 words long.

4. The computer program product of claim 1 further comprising: wherein the user selected computer programming language is a user-defined computer program design language that is at least 5 words long.

5. The computer program product of claim 1 further comprising:
at least one design entry template configured to provide the user the capability to capture a design logic of a system in such a way that all needed information is acquired to execute an instruction.

6. The computer program product of claim 5, further comprising:
wherein the at least one design entry template that captures the design logic of the system is configured to generate executable statements.

7. A method for facilitating processing within a computing environment, the method comprising:
implementing a software development cycle wherein the software development cycle comprises a design phase and an implementation phase; and
separating the design phase from the implementation phase of the software development cycle.

8. The method of claim 7 further comprising:
capturing a design during the design phase;
executing the design automatically;
generating design requirements;
generating design specifications; and
generating a computer source code program in a selected programming language.

9. The method of claim 7 further comprising:
creating a structured programming instruction manager configured to provide instruction management, organization, interaction, execution and serialization.

10. The method of claim 7 further comprising:
creating a structured programming instruction manager configured to:
verify all data; and
handle instruction nesting.

11. The method of claim 7 further comprising:
creating a structured programming instruction manager configured to:
determine what questions to ask a user;
generate the determined questions;
request a user input the necessary parameters, variables, and instruction type; and
receive from the user, the necessary parameters, variables, and instruction type.

12. The method of claim 7 further comprising:
creating a structured programming instruction manager configured to determine the order of the instructions to be executed.

13. A method comprising:
receiving a natural language instruction;
outputting a programming language instruction;
computing the programming language instruction;
generate, based on execution of the programming language instruction, at least one of: a resultant, a decision, an outcome, an output, and determined result.

14. The method of claim 13, further comprising: repeating via a repetition process as determined by the user.

15. A system comprising:
a processor;
a memory;
a user interface;
an output; and
a natural language processor.

16. The system of claim 15, further comprising wherein the natural language processor is configured to:
receive natural language user input;
processor the received natural language user input;
generate, based on a natural language conversion algorithm, a set of instructions formatted in a pseudocode;
input the pseudocode set of instructions;
generating based on the pseudocode set of instructions in a user selected programming language;
executing the generated instructions;
providing the executed result to the user.
